(19) United States
(12) Patent Application Publication
(10) Pub. No.: US 2025/0007321 A1
(43) Pub. Date: Jan. 2, 2025

(54) ELECTRONIC LOCK WITH IMPROVED POWER SCHEME

(71) Applicant: SentriLock, LLC, Cincinnati, OH (US)

(72) Inventor: Scott R. Fisher, West Chester, OH (US)

(73) Assignee: SentriLock, LLC, Cincinnati, OH (US)

(21) Appl. No.: 18/749,906

(22) Filed: Jun. 21, 2024

Related U.S. Application Data
(60) Provisional application No. 63/523,507, filed on Jun. 27, 2023.

(51) Int. Cl. H02J 7/34; G07C 9/00; H01G 11/04; H01M 10/0563; H02J 7/00

(52) U.S. Cl. CPC H02J 7/345; G07C 9/00944; H01G 11/04; H01M 10/0563; H02J 7/007192; G07C 2009/00642; G07C 2009/00952; H02J 2207/50

(57) ABSTRACT

An electronic lock that includes a hybrid capacitor in the power supply circuit that also includes a battery as the primary source of electrical power. A Li-SOCl2 battery is used as the primary power source, and the hybrid capacitor is used as a secondary (or backup) power source, and the power supply circuit disclosed herein overcomes many of the shortcomings of those two individual power sources. A proper combination of these two solutions is very complimentary in terms of delivering the power needs of electronic lock systems over a wide temperature range, operational conditions, and battery discharge states. The results obtained by use of this type of power supply circuit are increased primary battery longevity, increased performance at low temperatures, easier battery level sensing of the primary Li-SOCl2 cell, as well as overcoming the voltage delay that is present in primary batteries of this chemistry.

### CROSS-REFERENCE TO RELATED APPLICATIONS

The present application claims priority to provisional patent application Ser. No. 63/523,507, titled “ELECTRONIC LOCK WITH IMPROVED POWER SCHEME,” filed on Jun. 27, 2023.

### TECHNICAL FIELD

The technology disclosed herein relates generally to electronic lock equipment and is particularly directed to power supply circuits for use in electronic locks of the type which are typically powered by batteries. Embodiments are specifically disclosed as electronic locks that include a hybrid capacitor in the power supply circuit that also includes a battery as the primary source of electrical power. The disclosed power supply circuit uses the beneficial aspects of both types of power sources.

The power supply system disclosed herein marries the exceptional performance of hybrid capacitors with Li-SOCl2 (Lithium Thionyl Chloride) chemistry batteries. The Li-SOCl2 battery is used as the primary power source, and the hybrid capacitor is used as a secondary (or backup) power source, and the power supply circuit disclosed herein overcomes many of the shortcomings of those two individual power sources.

A proper combination of these two solutions is very complimentary in terms of delivering the power needs of electronic lock systems over a wide temperature range, operational conditions, and battery discharge states. The results obtained by use of this type of power supply circuit are increased primary battery longevity, increased performance at low temperatures, easier battery level sensing of the primary Li-SOCl2 cell, as well as overcoming the voltage delay that is present in primary batteries of this chemistry. Other advantages in the design will become apparent in the disclosure hereinbelow.

### STATEMENT REGARDING FEDERALLY SPONSORED RESEARCH OR DEVELOPMENT

None.

### BACKGROUND

Electronic locks in general, and electronic lockboxes specifically, often use batteries as their primary power source, especially when the electronic locks are installed in remote locations, particularly in outdoor environments. Present day electronic lockboxes typically use a primary battery made of a lithium-ion chemistry. Some of these current lockboxes include a back-up battery that may consist of a traditional double layer “super” capacitor (EDLC).

Hybrid capacitors are a relatively new technology that marries a traditional double layer “super” capacitor (an “EDLC,” or electric double layer capacitor) with lithium-ion battery technology. Hybrid capacitors such as Eaton's HS hybrid capacitor series can operate up to a working voltage of 3.8 volts, have leakage currents that are roughly 1/20 of traditional EDLC's in the same capacitance value, and have good equivalent series resistance. One potential drawback is the need to prevent discharge below 2.2 volts to ensure long life, which should be addressed in a circuit design that will use this type of hybrid capacitor in an electronic lockbox power system.

EDLC's typically lack the ability to individually operate above 2.5 volts, thus limiting their application, and they have leakage currents about 20 times greater than that of hybrid capacitors. Furthermore, EDLC's are physically larger in size compared to their hybrid capacitor counterparts, at equivalent capacitance values. EDLC's also do not perform well below −15 degrees C.

### SUMMARY

Accordingly, it is an advantage to provide an alternative power supply for a battery-powered electronic lock, in which a primary battery is used to provide energy through its useful life to a locking mechanism, while also charging a hybrid capacitor, and after the primary battery has become sufficiently discharged, the hybrid capacitor is then used to provide energy to that locking mechanism.

It is another advantage to provide a dual power source for an electronic lock, in which a first power source, such as a primary battery or a solar panel, is used to provide energy to a locking mechanism, while also charging a hybrid capacitor, and if the first power source is unable to provide sufficient energy, then a second power source, such as a hybrid capacitor is then used to provide energy to that locking mechanism.

It is still another advantage to provide an alternative power supply for a battery-powered electronic lock, in which a primary battery is used to provide energy through its useful life to a locking mechanism, while also charging a hybrid capacitor, and if the ambient temperature reaches a value below a predetermined threshold, and if the hybrid capacitor is sufficiently charged so as to be able to operate the locking mechanism, then regardless of the charge state of the primary battery the hybrid capacitor will then be used to provide energy to that locking mechanism.

It is yet another advantage to provide an alternative power supply for a battery-powered electronic lockbox, in which a primary battery is used to provide energy through its useful life to a lock driver circuit and its actuator, while also charging a hybrid capacitor, and after the primary battery has become sufficiently discharged, the hybrid capacitor is then used to provide energy to the lock driver circuit and its actuator, in which the actuator operates both a shackle release/relocking mechanism and a key bin release/relocking mechanism.

It is a further advantage to provide an alternative power supply for a battery-powered electronic lockbox, in which a primary battery is used to provide energy through its useful life to a lock driver circuit and its actuator, while also charging a hybrid capacitor, and after the primary battery has become sufficiently discharged, the hybrid capacitor is then used to provide energy to the lock driver circuit and its actuator, in which the actuator operates both a shackle release/relocking mechanism and a key bin release/relocking mechanism; moreover, if the hybrid capacitor has also become sufficiently discharged, then the functionality of the lock driver circuit and its actuator is restricted by the system controller such that only the lockbox's owner will be permitted to operate the lock driver circuit and its actuator.

It is a yet further advantage to provide an alternative power supply for a battery-powered electronic lockbox, in which a primary battery is used to provide energy through its useful life to a lock driver circuit and its actuator, while also charging a hybrid capacitor, and after the primary battery has become sufficiently discharged, the hybrid capacitor is then used to provide energy to the lock driver circuit and its actuator, in which the actuator operates both a shackle release/relocking mechanism and a key bin release/relocking mechanism; moreover, if the hybrid capacitor has become discharged to a further extent, then the functionality of the lock driver circuit and its actuator is restricted by the system controller such that only the lockbox's owner will be permitted to operate the lock driver circuit and its actuator, but only to release the shackle.

Additional advantages and other novel features will be set forth in part in the description that follows and in part will become apparent to those skilled in the art upon examination of the following or may be learned with the practice of the technology disclosed herein.

To achieve the foregoing and other advantages, and in accordance with one aspect, an electronic lockbox is provided, which comprises: (a) a housing; (b) an electronic control circuit, including: a computer processing circuit, a memory circuit including instructions executable by the processing circuit, an input/output interface circuit, and a power circuit; (c) a prime mover driver; (d) a primary battery; and (e) a hybrid capacitor; wherein: (i) if the primary battery has a sufficient charge to output an operable voltage, the primary battery actuates the prime mover driver; or (ii) if the primary battery is discharged so that the primary battery cannot output an operable voltage, the hybrid capacitor actuates the prime mover driver.

In accordance with another aspect, an electronic lockbox is provided, which comprises: (a) a housing; (b) an electronic control circuit, including: a computer processing circuit, a memory circuit including instructions executable by the processing circuit, an input/output interface circuit, and a power circuit; (c) a prime mover driver; (d) a primary battery; (e) a hybrid capacitor; and (f) a manual “on” switch; wherein: (i) if the primary battery has a sufficient charge to output an operable voltage, the primary battery actuates the prime mover driver; or (ii) if the primary battery is discharged so that the primary battery cannot output an operable voltage, the manual “on” switch may be actuated by a human user, and the hybrid capacitor actuates the prime mover driver.

In accordance with yet another aspect, a method for operating an electronic lockbox is provided, in which the method comprises: (a) providing: (i) a housing; (ii) an electronic control circuit, including: a computer processing circuit, a memory circuit including instructions executable by the processing circuit, an input/output interface circuit, and a power circuit; (iii) a prime mover driver; (iv) a primary battery; and (v) a hybrid capacitor; (b) actuating the prime mover driver using the primary battery if the primary battery has a sufficient charge to output an operable voltage; and (c) if the primary battery is so discharged that the primary battery cannot output an operable voltage, then actuating a manual “on” switch, and thereby actuating the prime mover driver using the hybrid capacitor.

In accordance with still another aspect, an electronic lockbox is provided, which comprises: (a) a housing; (b) an electronic control circuit, including: a computer processing circuit, a memory circuit including instructions executable by the processing circuit, an input/output interface circuit, and a power circuit; (c) a prime mover driver; (d) a primary battery; (e) a hybrid capacitor; and (f) a temperature sensor; wherein: (i) the ambient temperature is determined before the prime mover driver is activated; and (ii) if the ambient temperature is below a predetermined value, the hybrid capacitor circuit is used to provide electrical energy to the prime mover driver instead of the primary battery, without regard to the charge state of the primary battery.

In accordance with a further aspect, an electronic lockbox is provided, which comprises: (a) a housing; (b) an electronic control circuit, including: a computer processing circuit, a memory circuit including instructions executable by the processing circuit, an input/output interface circuit, and a power circuit; (c) a prime mover driver; (d) a primary battery; and (e) a hybrid capacitor; wherein: (i) if the primary battery charge state is insufficient to actuate the prime mover driver, then the electronic control circuit counts the number of consecutive times the hybrid capacitor is engaged to actuate the prime mover driver; and (ii) if the number of counts exceeds a predetermined value, then the electronic control circuit permits only the owner of the electronic lockbox to operate the prime mover driver.

In accordance with a yet further aspect, an electronic lockbox is provided, which comprises: (a) a housing; (b) an electronic control circuit, including: a computer processing circuit, a memory circuit including instructions executable by the processing circuit, an input/output interface circuit, and a power circuit; (c) a prime mover driver; (d) a shackle that is actuatable by the prime mover driver; (e) a key bin that is actuatable by the prime mover driver; (f) a primary battery; and (g) a hybrid capacitor; wherein: (i) if the primary battery charge state is insufficient to actuate the prime mover driver, then the electronic control circuit counts the number of consecutive times the hybrid capacitor is engaged to actuate the prime mover driver; and (ii) if the number of counts exceeds a predetermined value, then the electronic control circuit permits the prime mover driver to only release the shackle.

In accordance with a still further aspect, an electronic lockbox is provided, which comprises: (a) a housing; (b) an electronic control circuit, including: a computer processing circuit, a memory circuit including instructions executable by the processing circuit, an input/output interface circuit, and a power circuit; (c) a prime mover driver; (d) a primary battery; and (e) a hybrid capacitor; wherein: (i) if the hybrid capacitor voltage is below a predetermined threshold, and if the primary battery is discharged, then: (ii) the electronic control circuit permits only the owner of the electronic lockbox to operate the prime mover driver.

In accordance with an additional aspect, an electronic lockbox is provided, which comprises: (a) a housing; (b) an electronic control circuit, including: a computer processing circuit, a memory circuit including instructions executable by the processing circuit, an input/output interface circuit, and a power circuit; (c) a prime mover driver; (d) a primary battery; and (e) a hybrid capacitor; wherein: (i) if the primary battery charge state is insufficient to actuate the prime mover driver, then the electronic control circuit determines and stores a real time date in said memory circuit as to when the hybrid capacitor is first engaged to actuate the prime mover driver; (ii) if the hybrid capacitor has been the exclusive power source for the electronic lockbox since the hybrid capacitor was first engaged, then the electronic control circuit determines an operating factor based at least partially upon the elapsed time since the real time date was stored in the memory circuit; and (iii) if the present operating factor is below a predetermined threshold value, then the electronic control circuit permits only a predetermined, limited set of functions to be performed by the electronic lockbox.

Still other advantages will become apparent to those skilled in this art from the following description and drawings wherein there is described and shown a preferred embodiment in one of the best modes contemplated for carrying out the technology. As will be realized, the technology disclosed herein is capable of other different embodiments, and its several details are capable of modification in various, obvious aspects all without departing from its principles. Accordingly, the drawings and descriptions will be regarded as illustrative in nature and not as restrictive.

### BRIEF DESCRIPTION OF THE DRAWINGS

The accompanying drawings incorporated in and forming a part of the specification illustrate several aspects of the technology disclosed herein, and together with the description and claims serve to explain the principles of the technology. In the drawings:

FIG. 1 is a block diagram showing some of the major portions of an improved power scheme for a battery-powered electronic lockbox, as constructed according to the principles of the technology disclosed herein.

FIG. 2 is a schematic diagram of the improved power scheme of FIG. 1.

FIG. 3 is a block diagram showing some of the major hardware components used in an electronic lockbox that includes the improved power scheme of FIG. 1.

FIG. 4 is a front perspective view of an electronic lockbox that includes the improved power scheme of FIG. 1.

FIG. 5 is a front perspective view of the electronic lockbox of FIG. 4 showing the shackle and key bin detached.

FIG. 6 is a front view of the internal housing subassembly of the electronic lockbox of FIG. 4.

FIG. 7 is a flow chart showing some of the functions performed by a system controller that is part of the electronic lockbox of FIG. 1.

### DETAILED DESCRIPTION

Reference will now be made in detail to the present preferred embodiment, an example of which is illustrated in the accompanying drawings, wherein like numerals indicate the same elements throughout the views.

It is to be understood that the technology disclosed herein is not limited in its application to the details of construction and the arrangement of components set forth in the following description or illustrated in the drawings. The technology disclosed herein is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” or “mounted,” and variations thereof herein are used broadly and encompass direct and indirect connections, couplings, or mountings. In addition, the terms “connected” or “coupled” and variations thereof are not restricted to physical or mechanical connections or couplings. Furthermore, the terms “communicating with” or “in communications with” refer to two different physical or virtual elements that somehow pass signals or information between each other, whether that transfer of signals or information is direct or whether there are additional physical or virtual elements therebetween that are also involved in that passing of signals or information. Moreover, the term “in communication with” can also refer to a mechanical, hydraulic, or pneumatic system in which one end (a “first end”) of the “communication” may be the “cause” of a certain impetus to occur (such as a mechanical movement, or a hydraulic or pneumatic change of state) and the other end (a “second end”) of the “communication” may receive the “effect” of that movement/change of state, whether there are intermediate components between the “first end” and the “second end,” or not. If a product has moving parts that rely on magnetic fields, or somehow detects a change in a magnetic field, or if data is passed from one electronic device to another by use of a magnetic field, then one could refer to those situations as items that are “in magnetic communication with” each other, in which one end of the “communication” may induce a magnetic field, and the other end may receive that magnetic field, and be acted on (or otherwise affected) by that magnetic field.

The terms “first” or “second” preceding an element name, e.g., first inlet, second inlet, etc., are used for identification purposes to distinguish between similar or related elements, results or concepts, and are not intended to necessarily imply order, nor are the terms “first” or “second” intended to preclude the inclusion of additional similar or related elements, results or concepts, unless otherwise indicated.

In addition, it should be understood that embodiments disclosed herein include both hardware and electronic components or modules that, for purposes of discussion, may be illustrated and described as if the majority of the components were implemented solely in hardware.

However, one of ordinary skill in the art, and based on a reading of this detailed description, would recognize that, in at least one embodiment, the electronic based aspects of the technology disclosed herein may be implemented in software. As such, it should be noted that a plurality of hardware and software-based devices, as well as a plurality of different structural components may be utilized to implement the technology disclosed herein. Furthermore, if software is utilized, then the processing circuit that executes such software can be of a general purpose computer, while fulfilling all the functions that otherwise might be executed by a special purpose computer that could be designed for specifically implementing this technology.

It will be understood that the term “circuit” as used herein can represent an actual electronic circuit, such as an integrated circuit chip (or a portion thereof), or it can represent a function that is performed by a processing circuit, such as a microprocessor or an ASIC that includes a logic state machine or another form of processing element (including a sequential processing circuit). A specific type of circuit could be an analog circuit or a digital circuit of some type, although such a circuit possibly could be implemented in software by a logic state machine or a sequential processor. In other words, if a processing circuit is used to perform a desired function used in the technology disclosed herein (such as a demodulation function), then there might not be a specific “circuit” that could be called a “demodulation circuit;” however, there would be a demodulation “function” that is performed by the software. All of these possibilities are contemplated by the inventors, and are within the principles of the technology when discussing a “circuit.”

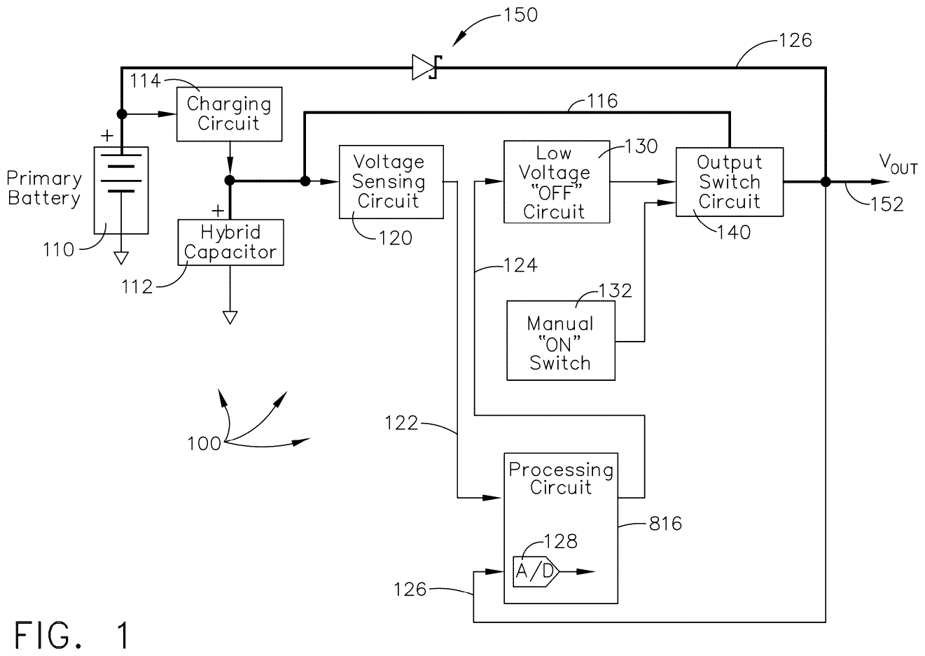

Referring now to FIG. 1, an improved power scheme that is generally referred to by the reference numeral 100 is illustrated in the form of a block diagram. Remotely-located electronic locks are often powered by a battery, and in this “power circuit” 100, there is a primary battery 110, and more specifically this typically is a lithium chemistry battery. The current that is output by the primary battery 110 is directed to two places: it goes to a charging circuit 114, and also through a Schottky diode 150 (also named D301), where it becomes the output voltage (V_{OUT}) of this power circuit 100, at a reference numeral 152.

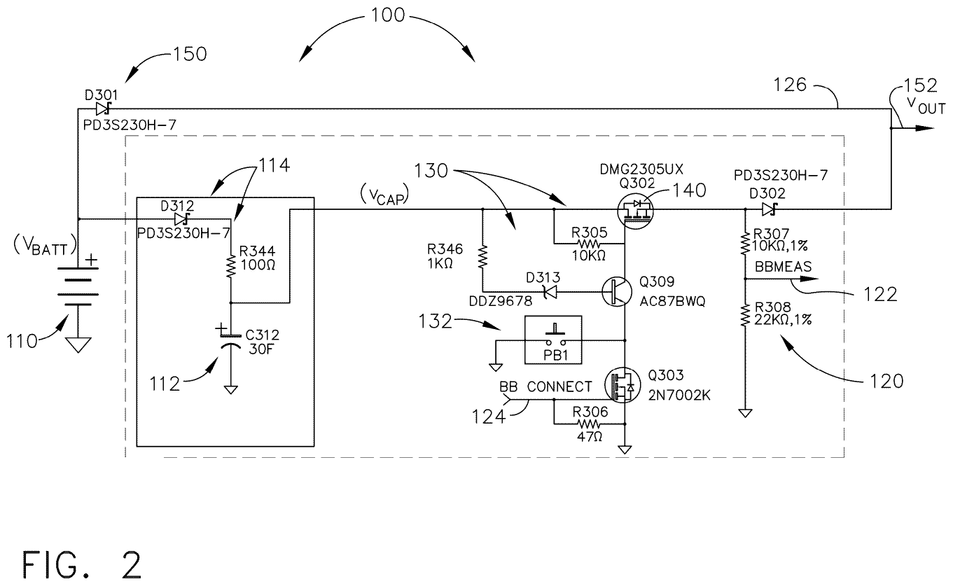

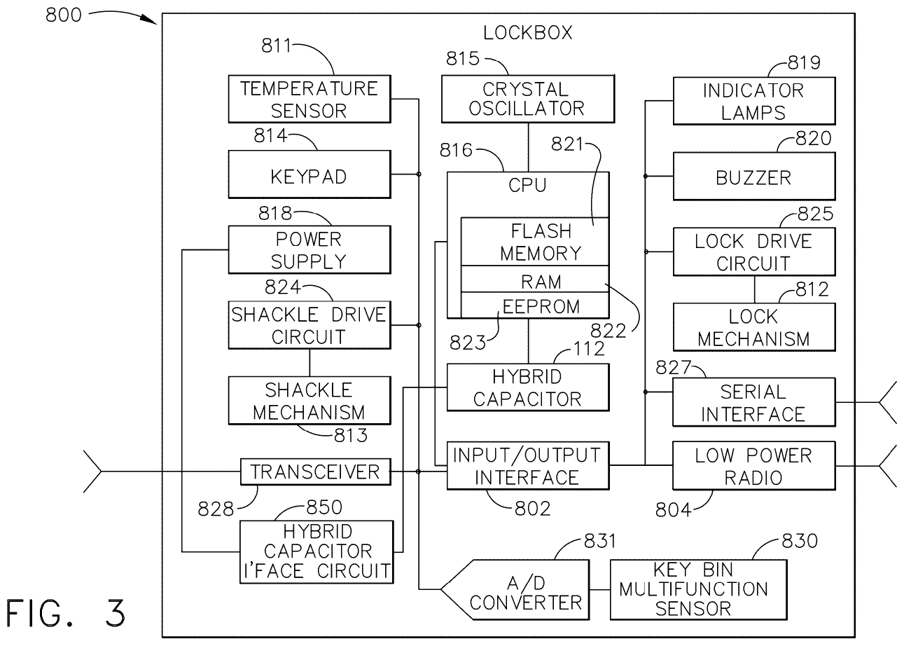

The charging circuit 114 is used to charge a hybrid capacitor 112. The output of the hybrid capacitor 112 (i.e., at its +V terminal) is connected to a “Voltage Sensing Circuit” 120. In this power scheme 100, the energy that would typically be available from a hybrid capacitor cannot be used until that hybrid capacitor has been charged to a sufficient voltage level. Therefore, the Voltage Sensing Circuit 120 will detect whether or not a sufficient voltage magnitude has been achieved by the hybrid capacitor, and the Voltage Sensing Circuit 120 outputs a signal 122 (also referred to as “BBMEAS”—see FIG. 2) to a processing circuit 816 (see also FIG. 3). This signal BBMEAS will be analyzed by the processing circuit 816, and when an appropriate magnitude of voltage from the hybrid capacitor has been achieved, the processing circuit 816 will send a signal at 124 (also referred to as “BBCONNECT”) to a special circuit 130 that is referred to on FIG. 1 as a “Low Voltage Off” circuit. This Low Voltage Off circuit 130 is an automatic voltage sensing circuit that must be satisfied for the hybrid capacitor's output current to be enabled for use by the electronic lock.

There is an ‘on’ circuit 132 that is designated on FIG. 1 as a “Manual On Switch.” This is a hardware pushbutton switch and, when actuated, it presents an input signal to an “Output Switching Circuit” 140. The “Low Voltage Off” circuit 130 also presents an output signal to the Output Switching Circuit 140. If both of these circuits 130 or 132 are in their ‘off’ state, then the Output Switching Circuit 140 will be disabled (turned off), and the current flow from the hybrid capacitor 112 will not be allowed to reach the V_{OUT} node at 152. And if either of these circuits 130 or 132 are in their ‘on’ state, then the Output Switching Circuit 140 will be enabled (turned on), and the current flow from the hybrid capacitor 112 will be allowed to reach the V_{OUT} at 152, if certain other conditions are met, involving the Voltage Sensing Circuit 120.

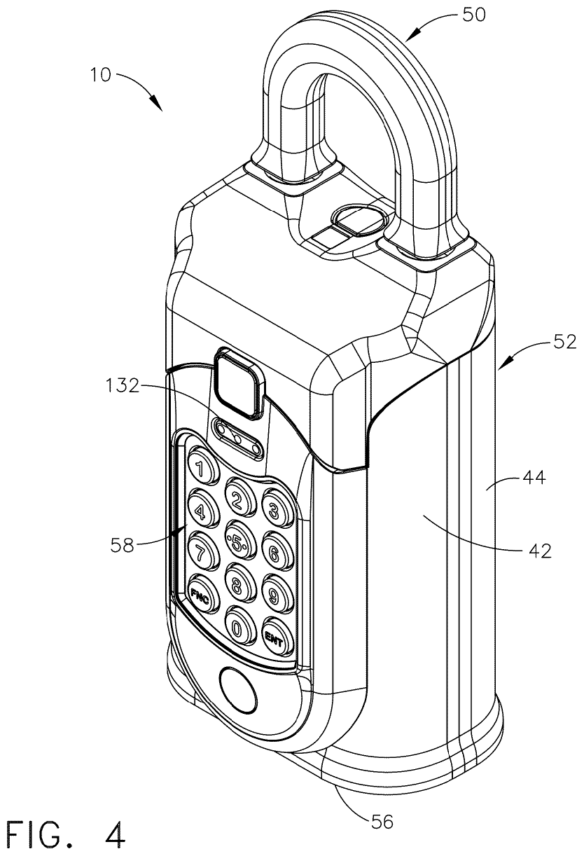

The V_{OUT} signal at the node 152 is the primary power supply voltage that powers all of the electronics of a given electronic lockbox 10 (see FIG. 4), including the actual locking mechanism itself. And note: many electronic lockboxes include two separate locking mechanisms, one to operate a “shackle release” type of lock 813, and the other to operate a “key bin release” type of lock 812. The V_{OUT} signal 152, powered by either the primary battery 110 or the hybrid capacitor 112—or by a combination of both power sources, if desired using an alternative circuit design—must be functional for the lockbox to successfully control either of those two types of locks.

It should be noted that either one of the primary battery 110 or the hybrid capacitor 112 will nominally have the ability to provide a sufficient voltage magnitude at the V_{OUT} terminal. If the primary battery 110 still has sufficient charge so as to provide an operable output voltage through the reverse current blocking (Schottky) diode D301 (at 150 on FIG. 2), then the output voltage V_{OUT} will be provided by the primary battery. If, however, the primary battery 110 has become discharged to the point where it cannot provide a sufficient voltage magnitude, then the hybrid capacitor 112 by itself can then provide sufficient energy to provide an appropriate voltage magnitude at V_{OUT}. Of course, neither energy source can last forever, but at least the hybrid capacitor 112 will nominally have the ability to open the electronic locking circuit many times after the primary battery 110 has become discharged to the point where it is no longer effective.

FIG. 2 provides a detailed schematic diagram of the electronic power circuit 100 for the present technology power scheme. The electronic lock power system normally relies on the Li-SOCl2 battery 110 for lock operation. The high ampere-hour capacity of the battery 110 coupled with its very stable 3.6 volts output and excellent performance down to −40° C. (even near 100% depletion) makes it an ideal choice for electronic locking devices. Unfortunately, these excellent features of this type of battery are also one of this battery's weaknesses—i.e., its near-constant discharge voltage makes measuring battery depletion state difficult until it is usually too late to warn the operator.

A second issue (or ‘weakness’) with these primary batteries is a condition called “voltage delay.” During inactivity, the battery anode passivates, increasing internal battery impedance, which limits current flow until the battery de-passivates during operation. The rate of Li-SOCl2 battery de-passivation is well understood, with the two primary factors being temperature and current flow. Very low temperature slows its reaction rate, which limits its output current, with the result being longer de-passivation times. This voltage delay is significant (often longer than the actuation time of the lock's electromechanical actuator) and thus can impede lock performance.

Electronic locks typically have short duration high current needs to activate their electromechanical actuators. The passivation effect creates a very low battery self-discharge, resulting in very long battery shelf life, but it impedes performance when long inactive periods are followed by a need for high current bursts. Significantly, electronic locks often have a long non-use period as part of their functional duty cycle (depending on their location of installation) and, therefore, passivation often occurs between operational cycles.

As seen in FIG. 2, the power circuit 100 includes a primary battery 110 of Li-SOCl2 chemistry as the primary power source for the main control circuit and its actuator elements, a charging circuit 114 for the hybrid capacitor 112, a voltage controlled electronic switch 140 to engage the hybrid capacitor (C312S) into the main power bus for the electronic lock, a “Battery Voltage Sensing Circuit” 128 (which is an A/D converter that is internal to the microprocessor) to measure the output voltage of the primary battery 110, and the separate Voltage Sensing Circuit 120 for ‘testing’ the output voltage of the hybrid capacitor, using a voltage divider circuit created by resistors R307 and R308.

The primary battery's output is passed through the hybrid battery charging circuit 114, which includes a reverse current blocking (Schottky) diode D312 and a current limiting resistor R344 in the current path to the hybrid capacitor 112. The size of resistor R344 is chosen to keep the capacitor charge current flow from the primary battery to a relatively low magnitude, such that the internal impedance of the battery 110 at nearly full discharge does not significantly reduce the battery's output voltage and, therefore, the ‘final’ charge voltage of the hybrid capacitor 112. (In this illustrated embodiment, the hybrid capacitor C312S has a value of 30 Farads.)

This relative low magnitude charging current for the hybrid capacitor 112 creates a capacitor “trickle charge” that maintains the hybrid capacitor voltage at close to the desired 3.6 volts system voltage very deep into the primary battery's discharge life—typically at about 98%. This is achievable because, as the hybrid capacitor charges, the current drain from the primary battery to the hybrid capacitor drops as the voltage rises due to the diminishing effect of the primary battery's internal impedance. The tendency of Li-SOCl2 battery cells to continue to provide close to the full charge voltage even when almost 100% discharged is a distinct advantage in this improved power scheme.

A power switching transistor Q302 is connected to the hybrid capacitor's “output side” of the circuit, and includes a logic control signal “enable” at 124, which is also referred to on FIG. 2 as the “BBCONNECT” signal. This “enable” signal 124 activates a switching transistor Q303, a manual enable logic switch 132, and a voltage sensitive switching circuit that includes a switching transistor Q309, a Zener diode D313, and a resistor R346. If the hybrid capacitor voltage falls below a predetermined threshold, the (manual and logic control) enable signal (see below) will be blocked by Q309, thereby preventing discharge of the hybrid capacitor below its technical minimum voltage level (typically at 2.2 volts).

When the “output side” of this circuit is enabled, either by logic control from the connected microprocessor (the BBCONNECT signal at 124) or from a manual enable by the human operator pressing the switch 132, and if the hybrid capacitor voltage is above the minimum discharge threshold, then current will flow through another current steering (Schottky) diode D302 and is “OR'd” with the primary battery (past its reverse current blocking diode D301) on the main power bus for the electronic lock (at V_{OUT}). Note that this Schottky diode D301 prevents dangerous back-charging of the primary battery (as a safety circuit 150).

The hybrid capacitor 112 has a very low ESR (equivalent series resistance) throughout its discharge range. A typical ESR is 550 milliohms with a 25 Farad capacitance. This low ESR means it can deliver a current pulse of high amperage (about 5 amperes) over multiple seconds, with capacitances as low as 25 Farads. This is ideal for electromechanical actuators, since nearly all have high inrush currents to drive gear motors and/or solenoids. This low ESR overcomes the high impedance of a primary battery in deep discharge, as well as any voltage delay due to passivation.

The low self-discharge of the hybrid capacitor (typically a few microamps) helps to provide for long primary battery life. The combination of Li-SOCl2 (the primary battery) and the hybrid capacitor results in the ability to extract about 10% more mechanical cycles out of the primary battery before it is depleted beyond its ability to produce sufficient current to operate the electronic lock. Using the improved power scheme described herein, even a “dead” battery (that cannot support the electronic lock with enough current to power up its processing electronics) that is connected with a hybrid capacitor, as described above and in FIG. 2, can operate the electronic lock successfully, after a few hours of slow charge of the hybrid capacitor from the depleted primary battery. This will allow emergency access (i.e., functional actuation) of that same electronic lock, if needed.

The power scheme described above also allows better determination and management of a “low battery” condition. As the Li-SOCl2 (primary) battery 110 reaches the roughly 80-85% discharge point, its internal impedance begins to rise, substantially restricting its ability to support high current loads, including even temporary loads like those found in electronic locks. There are two independent voltage measuring circuits: the primary battery voltage sensing circuit 128 that is internal to the microprocessor 816, and the Voltage Sensing Circuit 120 that measures the output voltage of the hybrid capacitor. Both of these voltage measuring circuits are coupled (via signals 122 and 126) to an analog-to-digital convertor (ADC) 128 that is mounted on the microprocessor (or microcontroller), such that real time voltage performance of each power source can be measured independently. The two voltage signals can either be fed to individual ADCs, or a multiplexer can be used with a single ADC. Note that the signal 126 is also the power supply voltage for the processing circuit 816; i.e., it is also used to provide the VDD power to that integrated circuit.

When under load with the hybrid capacitor engaged, these two voltages 122 and 126 can be evaluated differentially to determine the discharge state of the battery—i.e., the hybrid capacitor's output voltage is subtracted from the primary battery's output voltage creating a ‘delta V’ (ΔV) value. A higher voltage on the hybrid capacitor under known load compared to the voltage present on the primary battery over repeated operations, where the delta V (ΔV) between the two power sources increases over time, indicates a condition in which the primary battery is reaching its 100% discharge condition.

A fully depleted (discharged) primary battery with a fully charged hybrid capacitor can operate an electronic lockbox, such as the SentriLock SentriGuard® lockbox, up to 80 mechanical cycles, or for about six (6) months based on self-discharge measurements. During the state of full discharge of the primary battery, the quiescent current is quite low, as the electronic circuit is essentially “off” with respect to the hybrid capacitor. When the manual enable switch 132 is depressed, the hybrid capacitor is connected to the main power bus only if its voltage stage is above the avalanche voltage of the Zener diode D313. The microprocessor switches the logic circuit “on” during boot-up to maintain system power. A timer on the microprocessor turns the control line off after a predetermined short amount of time to preserve any backup power remaining in the hybrid capacitor. During operation in this “emergency/backup power” state, the software in the microprocessor can limit the functions of the electronic lock to maximize preservation of the power remaining in the hybrid capacitor.

The ESR of the hybrid capacitor remains relatively low, even at very cold temperatures, which provides yet another advantage of this power scheme. As the primary battery discharges through its life, the rising internal impedance becomes more of an issue, and de-passivation and resultant voltage delay of the battery takes longer due to the chemical reaction rate being slowed, thus limiting available current to drive the electromechanical actuator. In this situation, the hybrid capacitor acts as a current booster for the circuit, delivering the high pulse current needed to actuate the electromechanical actuator. This can eliminate the need for additional boost regulation circuits (and lower the overall cost).

It should be noted that, on FIG. 1, the heavier circuit pathways represent ‘load current’ pathways. In other words, a relatively high output current (at 152, or Vₒᵤₜ) will typically be experienced when the lockbox is actuated to perform either a locking or an unlocking function. If the primary battery 110 is providing that ‘high’ output current, then that current will flow through the pathway 126, through the diode 150. If the hybrid capacitor 112 is providing that ‘high’ output current, then the current will flow from the hybrid capacitor to the output switch circuit 140, through the pathway 116. It may appear unusual to see a ‘high’ current being output by the hybrid capacitor while its ‘input’ current (from the charging circuit 114) is not illustrated as being ‘high.’ It must be remembered that, in the illustrated power circuit 100, the hybrid capacitor is receiving only a ‘trickle charge’ from the primary battery.

A further explanation is needed for describing the operation of the voltage sensing circuit 120 and the low voltage “off” circuit 130. On FIG. 1, these circuits are depicted diagrammatically as occurring from left to right, in which the voltage sensing circuit 120 outputs a signal 122 to the processing circuit 816, which then (assuming one of the appropriate operating conditions is determined) will output a signal 124 to the low voltage “off” circuit 130 to turn on or off the output switch circuit 140. However, when viewing the schematic diagram of FIG. 2, it is clear that the signal 122 cannot exist (as a non-zero voltage) unless the output switch circuit 140 (i.e., transistor Q302) is turned on beforehand. But transistor Q302 cannot be automatically turned on unless the signal 124 (from the microprocessor 816) has first received an ‘OK’ signal at 122. (Note: Q302 can be turned on manually by operating the PB1 pushbutton at 132.)

This apparent dilemma is resolved as follows: the transistor Q302 is momentarily activated by the system controller (the microprocessor/microcontroller 816) to take a measurement through the voltage divider circuit 120, thereby producing a “BBMEAS” signal at 122, which is directed back to the system controller 816 for analysis. This only takes a few milliseconds, and it is performed according to the computer program that controls the system controller 816. In this manner, the status of the present output voltage of the hybrid capacitor can be quickly determined. Once this sample of the voltage at 122 is taken, the transistor Q302 is quickly turned back off, unless the hybrid capacitor has a sufficient charge to provide power to actuate the desired locking or unlocking functions.

Operation of the PB1 manual pushbutton switch 132 will also be further explained as follows: the human user will depress the switch's plunger, and hold it down long enough for a measurement to be taken of the primary battery's condition, and also to determine the hybrid capacitor's condition. If, for example, the primary battery is ‘dead,’ and if the hybrid capacitor's output voltage is ‘good,’ then the circuit will latch in by turning on the transistors Q303 and Q302, which will then allow current to flow from the hybrid capacitor to V_{OUT}—i.e., along the current pathway 116 on FIG. 1 to the node 152. When the human user first depresses the switches plunger, that act will also activate the system controller from a ‘sleep’ mode (of very low power drain), and the entire ‘boot up’ operation will typically take about 1 second to accomplish everything, including placing the lockbox in a mode in which the user can now operate the lock to open the key bin, or to release the shackle, as desired.

As discussed above, the voltage sensing circuit 120 and the low voltage “off” circuit 130 work in conjunction with the processing circuit 816 to automatically control the output switch circuit 140 which, when activated, effectively turns on the hybrid capacitor as a current “boost” for the electronic lockbox 10. This is sometimes referred to herein as the hybrid capacitor's “boost circuit,” and is an important part of the overall power circuit 100.

Referring now to FIG. 3, an electronic lockbox design is provided in a block diagram, which shows many of the major electronic components, generally designated by the reference numeral 800. Many of the components listed in this block diagram are also found in the earlier versions of electronic lockboxes sold by SentriLock, LLC of Cincinnati, Ohio. A brief description of these components follows.

The electronic circuit 800 includes a microprocessor (CPU) 816, FLASH memory 821, random access memory (RAM) 822, EEPROM (electrically erasable programmable read only memory) 823, an electrical power supply 818 (such as the primary battery 110), the hybrid capacitor 112, a hybrid capacitor interface circuit 850 (i.e., mainly the power circuit 100 seen on FIGS. 1 and 2), indicator LED lamps 819, a piezo buzzer 820, a crystal oscillator 815, a digital temperature sensor 811 (these last two devices can be combined into a single chip) a shackle drive circuit 824, a shackle release mechanism 813, a key compartment (key bin) mechanism drive circuit 825, a key compartment (key bin) lock/release mechanism 812, and a membrane style keypad 814 for user data entry.

A serial interface 827 is also included so that the CPU 816 is able to communicate with other external devices, such as a separate portable computer in the form of a smart phone, a PDA (personal digital assistant), or a tablet computer, or other type of portable computing device that uses a serial data link. For example, serial interface 827 can comprise an infrared (IR) port that communicates with a standard IR port found on many PDA's; or it could use a different communications protocol, such as Bluetooth (found on may smart phones). A low power radio 804 is included for communications with a portable electronic key or a smart phone (not shown on FIG. 4). This radio 804 could have any number of types of communications protocols, including one that allows the lockbox 10 to exchange data with an electronic key in the form of a smart phone. For example, a special software application program (an “APP”) would run on the smart phone, to allow it to communicate with lockbox 10.

The microprocessor 816 controls the operation of the electronic lockbox 10 according to programmed instructions (electronic lockbox control software) stored in a memory device, such as in FLASH memory 821. The RAM memory 822 is typically used to store various data elements such as counters, software variables and other informational data. EEPROM memory 823 is typically used to store more permanent electronic lockbox data such as serial number, configuration information, and other important data. It will be understood that many different types of microprocessors or microcontrollers could be used in the electronic lockbox 10, and that many different types of memory devices could be used to store data in both volatile and non-volatile form, without departing from the principles of this technology. In one mode of an exemplary embodiment, the electronic lockbox CPU 816 is a Texas Instruments part number CC2652R SimpleLink™ 2.4 GHz Wireless microcontroller that incorporates RAM 822, FLASH memory 821 and EEPROM memory 823 internally (as on-board memory). It will be understood that any comparable microcontroller could instead be used, along with the appropriate software written for that specific device; further, the microprocessor/microcontroller 816 essentially acts as the ‘system controller.’

The electronic lockbox 10 also includes a key bin multifunction sensor 830 and an A/D (analog-to-digital) converter 831 (also sometimes referred to herein as an “ADC”). The key bin multifunction sensor 830 is preferably a Hall effect sensor, such as a Texas Instruments DRV5053-series Analog-Bipolar Hall Effect Sensor, for example; but it will be understood that any comparable magnetic field sensor could instead be used. The key bin multifunction sensor 830 can detect different magnetic field levels, and then translates that into a variable analog output voltage. The A/D converter 831, periodically reads (samples) these different analog voltage levels, and periodically the sampled output signals from the ADC (as digital numeric values) are read to the CPU 816.

It should be noted that the A/D converter 831 could be a separate electronic device (essentially as depicted in the block diagram of FIG. 3) that has its digital output read by the microcontroller 816 as needed, or the microcontroller could include its own on-board A/D converter, basically performing in the same manner—i.e., the processing unit of such a microcontroller would periodically read the digital output of the on-board A/D converter. In the second (above) example, the microcontroller could be a powerful “all-in-one” type of electronic component, and could encompass at least the components 816, 821, 822, 823, and 831 that are illustrated on FIG. 3. Such a powerful device may well include the serial interface circuit 827 and the low power radio circuit 804.

The primary battery 110 normally provides the operating electrical power for the electronic lockbox. The hybrid capacitor 112 is used to provide temporary power when the battery 110 is operating in a “low battery” condition (as discussed above), or during replacement of battery 110. It will be understood that an alternative electrical power supply could be used if desired, such as a solar panel with the memory backup capacitor.

An input/output (I/O) interface circuit 802 is provided so the microprocessor 816 can exchange data and operational signals with external devices, or with other devices integral to the lockbox that require greater power than can be directly supplied by the microprocessor's pinouts. This puts the I/O circuit 802 in the pathway for virtually all signals that are used in the controlling of lockbox 10, including the data signals that are involved with the serial interface 827, and the low power radio 804.

Electronic lockbox 10 generally includes a shackle (see item 50 on FIG. 4) that is typically used to attach the lockbox 10 to a door handle or other fixed object. However, it should be noted that stationary versions of electronic lockboxes can be made that are permanently affixed to buildings, or another large object, and such stationary versions do not always require a shackle.

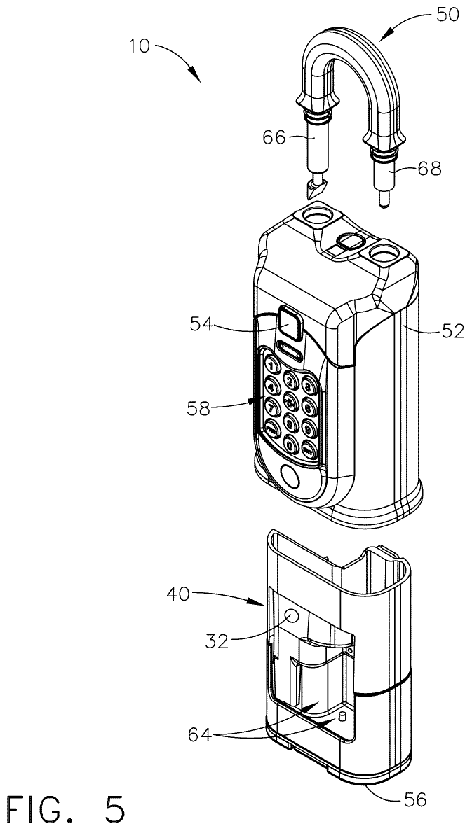

Electronic lockbox 10 also includes a key compartment 64 which typically holds a building or dwelling key, and which can be accessed via a movable bin 40 (see FIG. 5). The bin's lock and release mechanism 812 uses a motor mechanism (not shown) that is controlled by drive circuit 825 that in turn is controlled by CPU 816. Shackle release mechanism 813 also uses a motor, which is controlled by drive circuit 824 that in turn is controlled by CPU 816. It will be understood that the release or locking mechanisms used for the shackle and movable key bin can be constructed of many different types of mechanical or electromechanical devices without departing from the principles of the technology disclosed herein. It will also be understood that, in some physical locations, the lockbox may not require certain components that have been described above; for example, in some circumstances, a lockbox may not require a shackle. The crystal oscillator 815 provides a steady or near-constant frequency clock signal to CPU 816's asynchronous timer logic circuit.

In one embodiment, the digital temperature sensor 811 is read at regular intervals by the electronic lockbox CPU 816 to determine the ambient temperature. Crystal oscillator 815 may exhibit a small change in oscillating characteristics as its ambient temperature changes. In one type of crystal oscillator device, the oscillation frequency drift follows a known parabolic curve around a 25 degrees C. center. The temperature measurements are used by CPU 816 in calculating the drift of crystal oscillator 815 and thus compensating for the drift and allowing precise timing measurement regardless of electronic lockbox operating environment temperature. As noted above, a single chip can be used to replace the combination of crystal oscillator 815 and temperature sensor 811, such as a part number DS32KHZ manufactured by Dallas Semiconductor.

LED indicator lamps 819 and a piezo buzzer 820 are included to provide both an audible and a visual feedback of the operational status of the electronic lockbox 10. Their specific uses are described in detail in other patent documents by the same inventor. Hybrid capacitor 112 is charged by battery 110 (or perhaps by another power source) during normal operation.

The lockbox 10 can also be optionally equipped with a transceiver 828 that works with near field communications (“NFC”) equipment, and perhaps could be used to detect RFID chips, for example. In addition, such NFC circuits may be used for communicating with many other electronic products that have become common at many commercial establishments; so much so that most new smart phones are equipped with such an NFC transceiver (which typically includes a low-power microcontroller circuit).

Referring now to FIG. 4, an exemplary embodiment of an electronic lockbox is generally designated by the reference numeral 10. The lockbox 10 has an outer housing (or “enclosure” or “casing”) 52, the shackle 50, and a bottom portion at 56, which is part of a movable key bin that (when installed, or “closed” as illustrated in FIG. 4) is located at the bottom portion of the outer casing 52. The upper housing of lockbox 10 includes two receptacles (openings) that receive a shackle 50. The shackle 50 has an upper portion and two shackle extensions 66, 68 (see FIG. 5) that fit through the receptacles. The front of the lockbox has a keypad 58, which can be used by a sales agent or other authorized person to enter data to the lockbox's control system.

The keypad 58 may also be referred to as a “data input circuit,” in which a human user may press one or more of the keys to enter data, such as numeric information. It will be understood that future versions of electronic lockboxes may someday include a touchscreen display, and in such a design, the keypad will be incorporated directly into that display, and thus the touchscreen display itself would become the data input circuit. The keypad 58 is attached to a front portion 42 of the housing 52, while a rear portion 44 of the housing 52 is substantially planar. Above the keypad 58 is the manual “on” switch 132.

As noted above, electronic lockbox 10 includes a shackle 50 that is typically used to attach the lockbox 10 to a door handle or other fixed object. Electronic lockbox 10 also includes a key compartment (e.g., a movable key bin) which typically holds a building key (e.g., such as a dwelling key—not shown in this view), and which can be accessed via a movable key bin 40. The movable key bin 40 is essentially slidable into, and out of, a receiving space, which will also be referred to herein as a “movable key bin receptacle,” or simply a “bin receptacle,” that is part of the lockbox's main body.

Referring now to FIG. 5, the electronic lockbox 10 is shown with the shackle 50 released, and the movable key bin 40 detached. It should be noted that key bin 40 is unable to completely detach as illustrated, because a retainer (not shown) only allows the movable key bin to drop down, and not fully disengage (or detach) from the lockbox 10. The key bin 40 includes the key compartment 64 (e.g., part of the movable key bin 40) that will securely hold the building key, when the key bin is inserted (into its “closed” position) into the lockbox's main body.

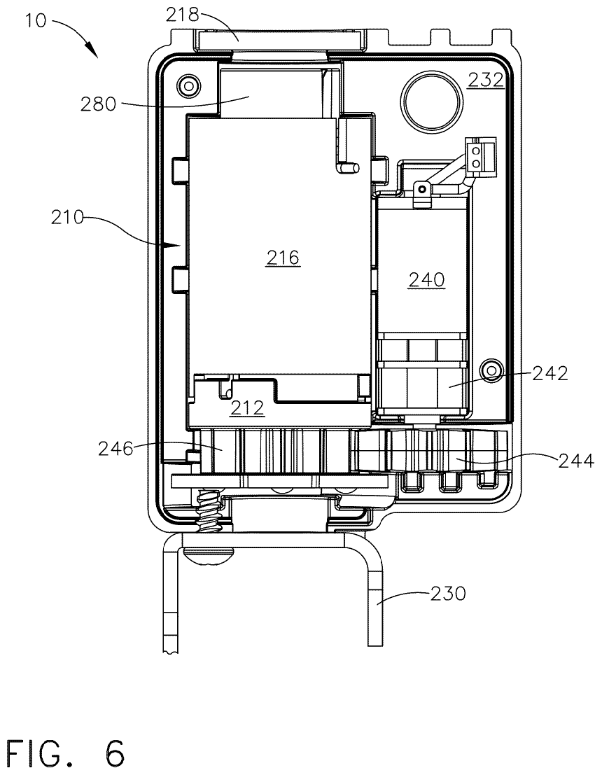

Referring now to FIG. 6, a barrel subassembly 210 (sometimes referred to herein as a “movable actuator”) is illustrated, along with other parts that together comprise a prime mover driver. An internal housing top opening 218 is shown at the top (in this view), with a barrel 280 directly below. Below the barrel 280 is a top sleeve 216, and below the top sleeve 216 is a bottom sleeve 212. Below the bottom sleeve 212 is a first spur gear 246. A bottom mounting bracket 230 is also shown.

Next to the top sleeve 216 and to the right (in this view) is a motor 240 (also sometimes referred to herein as a “prime mover”). The motor 240 is mounted to a motor mounting bracket (or a reduction gearbox) 242, and below the bracket 242 is a second spur gear 244. Above the motor is a mounting plate 232. The barrel subassembly 210, the first spur gear 246, the motor 240, and the second spur gear 244 together comprise the prime mover driver.

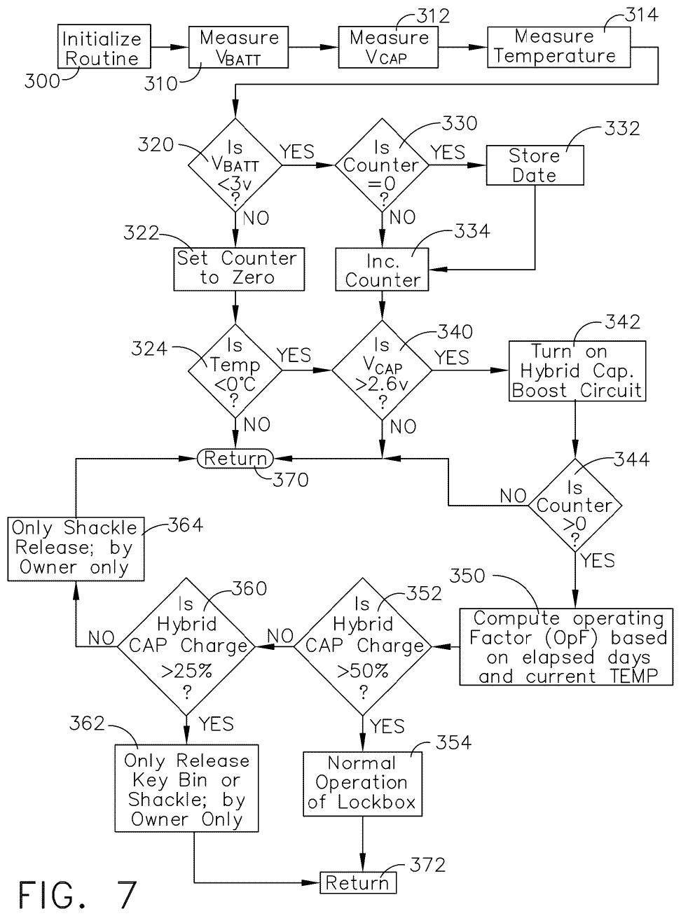

Referring now to FIG. 7, a flow chart is provided that includes many of the important functions used in the illustrated embodiment electronic lockbox. After an initializing function at the reference numeral 300 is performed, a function 310 measures the output voltage of the primary battery 110, known as V_{BATT} (see FIG. 2). A function 312 measures the output voltage of the hybrid capacitor, known as V_{CAP} (see FIG. 2). As described above, these voltage values are to be converted into numeric values for later use by the system controller, and as discussed below in connection with this flow chart of FIG. 7.

A function 314 measures the ambient temperature, using the temperature sensor 811 (see FIG. 3). This temperature data is to be converted into a numeric value, known as “TEMP”, for later use by the system controller, as discussed below in connection with this flow chart of FIG. 7. (These above numeric conversions are typically performed by an A/D converter.)

A function 320 now determines if the battery voltage V_{BATT} is less than three (3) volts. (Note: the reader is reminded that the numeric voltage values discussed in this explanation of the flow chart of FIG. 7 are for the illustrated embodiment, and would depend on the exact types of integrated circuits and other electronic components used for the system controller and in the power circuit 100, and of course, on the exact type of primary battery used and on the exact type of hybrid capacitor used.) If the answer is NO at function 320, which means that the primary battery is still properly functional (i.e., it still contains a charge that is sufficient to actuate the prime mover driver—e.g., the lock drive circuit 825 and/or the shackle drive circuit 824), then the logic flow is directed to a function 322 that ‘zeros’ a counter, which will be referred to herein as “Counter N.” In other words, Counter N is set to a value of zero. This should be the nominal situation of the charge state of the primary battery 110 during most of its life as the normal power source for the lockbox 10.

However, even though the above circumstance may be the ‘nominal’ situation of the primary battery, that battery 110 may not be the desirable source of power under all conditions. A function 324 first must determine if the ambient temperature is less than zero degrees C., and if not (which means that it is ‘safe’ to use the primary battery as the power source), then the logic flow is then directed to a “RETURN” function 370, and the processing circuit will then return to executing other functions for the lockbox 10. This would include a function of actuating the prime mover driver (e.g., either the shackle drive circuit 824 or the lock drive circuit 825). Note that many electronic lockboxes use a single main actuator to operate both the shackle drive circuit 824 and the lock drive circuit 825, although that single main actuator may be operated in opposite directions, or using separate associated mechanical parts. The term “prime mover driver” includes the necessary electrical and electronic components to actuate both the shackle mechanism 813 and the lock mechanism 812, whether those mechanisms use a single actuator or use two different actuators.

If the result at function 320 was YES, then a function 330 determines if the value of Counter N is equal to zero. If the answer is YES, then a function 332 stores the present date of this event, which will be referred to later in this flow chart. Then a function 334 increments the value of Counter N, which also will be referred to later in this flow chart. However, if the answer was NO at function 330, then the logic flow essentially will skip the “storing the date” function 332, and will instead be directed from function 330 to function 334, which then increments the value of Counter N.

After the function 334 increments Counter N, a function 340 determines if the output voltage of the hybrid capacitor (the V_{CAP} voltage) is greater than two (2) volts. This same function 340 is invoked if the function 324 had determined that the present ambient temperature was less than zero degrees C. As noted above, if the ambient temperature is greater than or equal to zero degrees C., then it is ‘safe’ to use the primary battery as the power source for the prime mover driver. But otherwise, it is much better to use the hybrid capacitor as that power source, as explained above, because of voltage delay due to passivation of many primary batteries, especially at low temperatures.

However, and again as explained above, if the hybrid capacitor's output voltage V_{CAP} is not greater than two (2) volts, then the hybrid capacitor should not be used as the power source, after all. Therefore, if the function 340 determines this to be the present situation, then the logic flow is directed to the “RETURN” function 370, and the processing circuit will then return to executing other functions for the lockbox 10. This could include attempting to actuate the prime mover driver using the primary battery 110, even though the ambient temperature is below zero degrees C. Of course, that actuating function may, or may not, succeed. The alternative is to not even allow the power circuit 100 to attempt to actuate the prime mover driver at such a cold ambient temperature. This operational decision is up to the lockbox system designer.

Assuming the hybrid capacitor output voltage V_{CAP} is indeed greater than two (2) volts, then the logic flow will proceed from function 340 to a function 342, which will then turn on the hybrid capacitor's “boost circuit.” In other words, the hybrid capacitor may have sufficient charge to be able to actuate the prime mover driver, although that is yet to be determined. What is determined at function 342 is that the hybrid capacitor 112 at least is not so discharged that its next use would permanently damage itself.

After the hybrid capacitor's “boost circuit” is turned on at function 342, a function 344 determines if the value of Counter N is greater than zero. If not, then the logic flow is directed to the “RETURN” function 370, and the processing circuit will then return to executing other functions for the lockbox 10. Again, this could include attempting to actuate the prime mover driver, but this time it would be using the hybrid capacitor as the power source.

On the other hand, if the function 344 determined that the value of Counter N is greater than zero, then a function 350 would now compute an “operating factor” variable (referred to herein as the “OpF”), which is based on the elapsed number of days after the date that was stored at function 332, and also is based on the current ambient temperature, and also on the actual numeric value of Counter N. Assuming the hybrid capacitor had received a full charge from the primary battery, then the “OpF” would begin with a value at or near 100%, if the elapsed time (number of days) was minimal, the value of Counter N was minimal (at “1”, for example), and the ambient temperature was above zero degrees C.

Of course, if the above assumptions are incorrect, then the value of “OpF” will begin to decrease every time another day goes by, or every time the hybrid capacitor is actually used as the power source (which will increase the Counter N value), or if the ambient temperature remains below zero degrees C. The rate of decrease of the “OpF” variable will greatly depend on many things, not the least of which is the overall lockbox design that will of course impact how much electrical current is needed to actuator the prime mover driver. The actual leakage current of the hybrid capacitor itself is another important determining factor; certain hybrid capacitors may only last for about six months—even if not used as a power source—due to leakage current alone. This makes the elapsed time (counted in days, for example) a very important consideration. And of course, if the value of Counter N reaches a predetermined threshold value—which (again) depends on the overall lockbox design—then it can be assumed that the hybrid capacitor will become more limited in its capabilities.

In view of all the above factors, a function 352 will determine if the hybrid capacitor still contains an operating charge of over 50%. If so, then a function 354 will allow normal operation of the lockbox 10 for all purposes, including to open its key bin so a real estate “showing agent” (such as a REALTOR®) can gain access to the building key. The logic flow will progress to a “RETURN” function 372, which is similar to the RETURN function 370. However, if the function 352 determined that the hybrid capacitor does not contain an operating charge of over 50%, then the overall conclusion is that the hybrid capacitor has become discharged to a point where its capability is at least somewhat limited.

Under this new circumstance, a function 360 will now determine if the hybrid capacitor still contains an operating charge of over 25%. If so, then a function 362 will restrict the functionality of the lockbox 10 so that only the owner of the lockbox will be allowed to operate the prime mover driver, either to release the shackle or to open the key bin. In a real estate sales setting, the lockbox owner is typically also referred to as the “listing agent,” who often also is a REALTOR®. In essence, once the hybrid capacitor has been discharged to the point in which it may only have just over 25% of its charge remaining, then it is time to prevent any real estate showing agents from operating that lockbox 10. The logic flow will then progress to the “RETURN” function 372.

If function 360 determined that the hybrid capacitor did not contain an operating charge of over 25%, then a function 364 will further limit the capability of that lockbox 10. In that circumstance, only the lockbox owner may operate that lockbox, but now the only function that will be permitted will be to release the shackle. In other words, the prime mover driver may be operated, but only to operate the shackle drive circuit 824. This lockbox needs a new primary battery, now.

It should be noted that the Counter N value will increase only if the hybrid capacitor is the sole provider of electrical power for the lockbox operations. In other words, if a new primary battery 10 is installed in a given lockbox 10, then the function 320 will quickly detect a new V_{BATT} voltage of greater than three (3) volts, and the value of Counter N will be reset to zero by function 322. When that occurs, then the next time that this function 320 would actually determine that the V_{BATT} voltage has again fallen to less than three (3) volts, that event would not likely occur until years later, and the hybrid capacitor would certainly have been fully recharged by then, and therefore, when function 330 would be first activated anew, the count value of Counter N would still be at zero, which means that a new date (of when that occurs) would therefore be stored in memory by the function 332. This would begin anew the later functions of incrementing the counter and measuring the ambient temperature (at 324) and the hybrid capacitor voltage V_{CAP} (at 340).

Another possible circumstance that could lead to resetting the value of the Counter N is as follows: if the ambient temperature is very cold, the primary battery 110 could exhibit an output voltage that is below three (3) volts, and thus ‘fail’ the test of the function 320, even if the primary battery is not necessarily at the end of its useful life. If that situation actually should occur, then the Counter N will start incrementing (at 334), the date will be stored (at 332), and the hybrid capacitor may well become engaged to provide the electrical power for the prime mover driver, or perhaps for other lockbox functions.

But then, if the ambient temperature significantly warms, the primary battery may be able to sufficiently recover to a point in which its output voltage V_{BATT} again rises to above three (3) volts. If that occurs, then the hybrid capacitor would not be used as the power source, and most likely, the hybrid capacitor would become fully recharged, even if the hybrid capacitor had been used a significant number of times while the ambient temperature remained very cold, and the primary battery would not have been used. In this scenario, the primary battery 110 would likely not last much longer, but at least the hybrid capacitor would have been recharged, and the Counter N value would be able to start over from zero, with yet another new date being stored by function 332. This scenario is an example of the great flexibility of the power circuit 100, as disclosed herein.

It will be understood that certain conditions that are not nominal can generate an “alarm” state in the electronic lockbox that could be sent as a wireless status message to the “electronic key” that is being used by the human user of the lockbox. In the technology disclosed herein, an example of a non-nominal condition would be a situation in which the hybrid capacitor is called upon to supply the current to actuate the electronic locking mechanism. For a lockbox, that ‘electronic locking mechanism’ could either be used to open the key bin, or to release the shackle. In a preferred mode of operation, the lockbox would send the “alarm” status message to the user's electronic key (such as a smart phone), and later, when the user's electronic key communicates with a central computer (such as a central clearinghouse computer) to make future appointments or to rejuvenate the electronic key, for example, then the electronic key would automatically send that “alarm” status message to the central computer, which would then send a similar message to the owner of that specific lockbox, to inform that owner of the need to replace the primary battery for that lockbox. These functions of making future appointments and rejuvenating electronic keys are described in detail in other patent documents by the inventors at SentriLock, LLC in Cincinnati, Ohio. See a list below of example patent documents.

It will also be understood that the principles of operation, as well as the circuit designs, that are disclosed herein and in the accompanying drawings are applicable to virtually any type of electronic lock that is battery-powered. The main difference between an electronic lock and an electronic lockbox is that the lockbox typically includes some type of secure compartment to hold a building key (or the like), and also typically includes a shackle to hold the lockbox to a doorknob or other solid object, whereas an electronic lock may not have either of those two items, yet will still have an actuator that opens (unlocks) or closes (locks) a door, or some other type of entrance. Of course, if an electronic lockbox includes both a shackle and a secure compartment, then its locking/unlocking actuator will need to be able to individually operate both of those items, whereas a typical electronic lock will only need to actuate a single item—i.e., the locking mechanism itself. From that standpoint, an electronic lockbox is a more complex piece of equipment.

It will be further understood that the primary battery described herein could be replaced with a solar panel, if desired. For example, if a solar panel is used during daylight hours to energize an electronic lock, and to also supply electrical current to a hybrid capacitor, then the hybrid capacitor would always have a ‘full charge’ state at the end of the daylight hours, and then could supply current to the electronic lock during the night hours. Depending of the size of the electronic locking mechanism, and depending on how many locking and unlocking functions that particular electronic lock is expected to undergo in a single night, the size and/or quantity of hybrid capacitors may need to be significantly increased, as compared to what is typically required to operate a real estate electronic lockbox.

Some additional information about “basic” lockbox embodiments, including advanced features, are more fully described in earlier patent documents by some of the same inventors, and assigned to SentriLock, Inc. or SentriLock LLC, including: U.S. Pat. No. 7,009,489, issued Mar. 7, 2006, for ELECTRONIC LOCK SYSTEM AND METHOD FOR ITS USE; U.S. Pat. No. 6,989,732, issued Jan. 24, 2006, for ELECTRONIC LOCK SYSTEM AND METHOD FOR ITS USE WITH CARD ONLY MODE; U.S. Pat. No. 7,086,258, issued Aug. 8, 2006, for ELECTRONIC LOCK BOX WITH SINGLE LINEAR ACTUATOR OPERATING TWO DIFFERENT LATCHING MECHANISMS; U.S. Pat. No. 7,420,456, issued Sep. 2, 2008, for ELECTRONIC LOCK BOX WITH MULTIPLE MODES AND SECURITY STATES; U.S. Pat. No. 7,193,503, issued Mar. 20, 2007, for ELECTRONIC LOCK SYSTEM AND METHOD FOR ITS USE WITH A SECURE MEMORY CARD; U.S. Pat. No. 7,999,656, issued Aug. 16, 2011, for ELECTRONIC LOCK BOX WITH KEY PRESENCE SENSING; U.S. Pat. No. 7,734,068, issued Jun. 8, 2010, for ELECTRONIC LOCK BOX USING A BIOMETRIC IDENTIFICATION DEVICE; U.S. Pat. No. 8,451,088, issued May 28, 2013, for ELECTRONIC LOCK BOX WITH TRANSPONDER BASED COMMUNICATIONS; U.S. Pat. No. 8,164,419, issued Apr. 24, 2012, for ELECTRONIC LOCK BOX WITH TIME-RELATED DATA ENCRYPTION BASED ON USER-SELECTED PIN; U.S. Pat. No. 8,151,608, issued Apr. 10, 2012, for ELECTRONIC LOCK BOX WITH MECHANISM IMMOBILIZER FEATURES; U.S. Pat. No. 9,208,466, issued on Nov. 18, 2015, for ELECTRONIC LOCK BOX SYSTEM WITH INCENTIVIZED FEEDBACK; U.S. Pat. No. 8,593,252, issued Nov. 26, 2013, for ELECTRONIC LOCK BOX PROXIMITY ACCESS CONTROL; U.S. Pat. No. 8,912,884, issued Dec. 16, 2014, for ELECTRONIC KEY LOCKOUT CONTROL IN LOCKBOX SYSTEM; U.S. Pat. No. 9,053,629, issued on May 20, 2015, for CONTEXTUAL DATA DELIVERY TO MOBILE USERS RESPONSIVE TO ACCESS OF AN ELECTRONIC LOCKBOX; U.S. Pat. No. 9,478,083, issued on Oct. 5, 2016, for ELECTRONIC KEY LOCKOUT CONTROL IN LOCKBOX SYSTEM; U.S. Pat. No. 9,704,315, issued on Jun. 21, 2017, for CONTEXTUAL DATA DELIVERY TO OTHER USERS AT AN ELECTRONIC LOCKBOX; U.S. Pat. No. 10,068,399, issued on Aug. 21, 2018, for CONTEXTUAL DATA DELIVERY TO OTHER USERS AT AN ELECTRONIC LOCKBOX; U.S. Pat. No. 10,026,250, issued on Jun. 27, 2018, for CONTEXTUAL DATA DELIVERY TO USERS AT A LOCKED PROPERTY; U.S. patent application No. 2020/0308870, published on Oct. 1, 2020, for IMPROVED ELECTRONIC LOCKBOX; U.S. patent application No. 2020/0308868, published on Oct. 1, 2020, for IMPROVED ELECTRONIC LOCKBOX; U.S. patent application No. 2020/0308869, published on Oct. 1, 2020, for IMPROVED ELECTRONIC LOCKBOX; U.S. patent application No. 2020/0312067, published on Oct. 1, 2020, for IMPROVED ELECTRONIC LOCKBOX; and U.S. patent application No. 2020/0308871, published on Oct. 1, 2020, for IMPROVED ELECTRONIC LOCKBOX. These patent documents are incorporated by reference herein, in their entirety.

It will also be understood that the precise logical operations depicted in the flow chart of FIG. 7, and discussed above, could be somewhat modified to perform similar, although perhaps not exact, functions without departing from the principles of the technology disclosed herein. The exact nature of some of the decisions and other commands in these flow charts are directed toward specific future models of electronic locking systems (those involving lockboxes sold by SentriLock, LLC, for example) and certainly similar, but somewhat different, functions/decisions would be taken for use with other models or brands of electronic locking systems in many instances, with the overall inventive results being the same.

It will be further understood that certain electronic components and circuits described herein could be modified so that a processing circuit, such as a logic state machine or a microcomputer, could replace some of those components. For example, the power circuit 100 includes voltage-sensing circuitry, such as the Zener diode circuit at 130, which could be replaced by an A/D converter to detect the magnitude of the hybrid capacitor's output voltage, if desired. In that type of alternative embodiment, the numeric value that would be output by the A/D converter could be compared to a predetermined threshold value by the processing circuit, and under appropriate conditions, the processing circuit could then turn on a switching transistor (such as transistor 140) to allow the hybrid capacitor to provide current at the V_{OUT} node 152. The processing circuit in this alternative embodiment could also be used to ‘measure’ the magnitude of the primary battery's output voltage, again using an A/D converter that would output a numeric value to the processing circuit, or to ‘measure’ the charging current received by the hybrid capacitor, either as absolute numbers, or as comparative numbers, as desired by the system designer.

As used herein, the term “proximal” can have a meaning of closely positioning one physical object with a second physical object, such that the two objects are perhaps adjacent to one another, although it is not necessarily required that there be no third object positioned therebetween. In the technology disclosed herein, there may be instances in which a “male locating structure” is to be positioned “proximal” to a “female locating structure.” In general, this could mean that the two (male and female) structures are to be physically abutting one another, or this could mean that they are “mated” to one another by way of a particular size and shape that essentially keeps one structure oriented in a predetermined direction and at an X-Y (e.g., horizontal and vertical) position with respect to one another, regardless as to whether the two (male and female) structures actually touch one another along a continuous surface. Or, two structures of any size and shape (whether male, female, or otherwise in shape) may be located somewhat near one another, regardless if they physically abut one another or not; such a relationship could still be termed “proximal.” Or, two or more possible locations for a particular point can be specified in relation to a precise attribute of a physical object, such as being “near” or “at” the end of a stick; all of those possible near/at locations could be deemed “proximal” to the end of that stick. Moreover, the term “proximal” can also have a meaning that relates strictly to a single object, in which the single object may have two ends, and the “distal end” is the end that is positioned somewhat farther away from a subject point (or area) of reference, and the “proximal end” is the other end, which would be positioned somewhat closer to that same subject point (or area) of reference.

It will be understood that the various components that are described and/or illustrated herein can be fabricated in various ways, including in multiple parts or as a unitary part for each of these components, without departing from the principles of the technology disclosed herein. For example, a component that is included as a recited element of a claim hereinbelow may be fabricated as a unitary part; or that component may be fabricated as a combined structure of several individual parts that are assembled together. But that “multi-part component” will still fall within the scope of the claimed, recited element for infringement purposes of claim interpretation, even if it appears that the claimed, recited element is described and illustrated herein only as a unitary structure.

All documents cited in the Background and in the Detailed Description are, in relevant part, incorporated herein by reference; the citation of any document is not to be construed as an admission that it is prior art with respect to the technology disclosed herein.

The foregoing description of a preferred embodiment has been presented for purposes of illustration and description. It is not intended to be exhaustive or to limit the technology disclosed herein to the precise form disclosed, and the technology disclosed herein may be further modified within the spirit and scope of this disclosure. Any examples described or illustrated herein are intended as non-limiting examples, and many modifications or variations of the examples, or of the preferred embodiment(s), are possible in light of the above teachings, without departing from the spirit and scope of the technology disclosed herein. The embodiment(s) was chosen and described in order to illustrate the principles of the technology disclosed herein and its practical application to thereby enable one of ordinary skill in the art to utilize the technology disclosed herein in various embodiments and with various modifications as are suited to particular uses contemplated. This application is therefore intended to cover any variations, uses, or adaptations of the technology disclosed herein using its general principles. Further, this application is intended to cover such departures from the present disclosure as come within known or customary practice in the art to which this technology disclosed herein pertains and which fall within the limits of the appended claims.

What is claimed is:

1. An electronic lockbox comprising:
(a) a housing;
(b) an electronic control circuit, including: a computer processing circuit, a memory circuit including instructions executable by the processing circuit, an input/output interface circuit, and a power circuit;
(c) a prime mover driver;
(d) a primary battery; and
(e) a hybrid capacitor;
wherein:
(i) if the primary battery has a sufficient charge to output an operable voltage, the primary battery actuates the prime mover driver; or
(ii) if the primary battery is discharged so that the primary battery cannot output an operable voltage, the hybrid capacitor actuates the prime mover driver.

2. The electronic lockbox of claim 1, wherein:
said prime mover driver includes a movable actuator, a first spur gear, a prime mover, and a second spur gear.

3. The electronic lockbox of claim 2, further comprising:
a key bin that is either locked in place or is released by the movable actuator, which is under the control of the computer processing circuit; and
a shackle that is either locked in place or is released by the movable actuator, which is under the control of the computer processing circuit.

4. The electronic lockbox of claim 1, wherein:
said primary battery charges said hybrid capacitor.

5. The electronic lockbox of claim 1, wherein:
said primary battery comprises a LiSOCl2 chemistry.

6. The electronic lockbox of claim 1, further comprising:
a charging circuit that receives electrical energy from the primary battery, and charges the hybrid capacitor;
a first voltage measuring circuit that determines if the primary battery has sufficient charge to actuate the prime mover driver;
a second voltage measuring circuit that determines if the hybrid capacitor has sufficient charge to actuate the prime mover driver;
if the primary battery has sufficient charge, then the hybrid capacitor is not used to supply power to the prime mover driver; and
if the primary battery does not have sufficient charge, then the hybrid capacitor is used to supply power to the prime mover driver.

7. The electronic lockbox of claim 6, further comprising:
a manually operated switch that activates the second voltage measuring circuit;
wherein: if the primary battery does not have sufficient charge, and if the hybrid capacitor has sufficient charge to actuate the prime mover driver, then a human user, by use of the manually operated switch, may command the electronic lockbox to actuate the prime mover driver to:
(i) release a shackle, or
(ii) to unlock a key bin, or
(iii) to both release the shackle and to unlock the key bin.

8. The electronic lockbox of claim 6, wherein:
(a) if the hybrid capacitor voltage is below a predetermined threshold, and if the primary battery is discharged, then:
(b) the electronic control circuit permits only the owner of the electronic lockbox to operate the prime mover driver.

9. An electronic lockbox comprising:
(a) a housing;
(b) an electronic control circuit, including: a computer processing circuit, a memory circuit including instructions executable by the processing circuit, an input/output interface circuit, and a power circuit;
(c) a prime mover driver;
(d) a primary battery;
(e) a hybrid capacitor; and
(f) a temperature sensor;
wherein:
(i) the ambient temperature is determined before the prime mover driver is activated; and
(ii) if the ambient temperature is below a predetermined value, the hybrid capacitor circuit is used to provide electrical energy to the prime mover driver instead of the primary battery, without regard to the charge state of the primary battery.

10. The electronic lockbox of claim 9, wherein: the power circuit is used to determine if the charge state of the hybrid capacitor is sufficient to actuate the prime mover driver.

11. An electronic lockbox comprising:
(a) a housing;
(b) an electronic control circuit, including: a computer processing circuit, a memory circuit including instructions executable by the processing circuit, an input/output interface circuit, and a power circuit;
(c) a prime mover driver;
(d) a primary battery; and
(e) a hybrid capacitor;
wherein:
(i) if the primary battery charge state is insufficient to actuate the prime mover driver, then the electronic control circuit determines and stores a real time date in said memory circuit as to when the hybrid capacitor is first engaged to actuate the prime mover driver;
(ii) if the hybrid capacitor has been the exclusive power source for the electronic lockbox since the hybrid capacitor was first engaged, then the electronic control circuit determines an operating factor based at least partially upon the elapsed time since the real time date was stored in the memory circuit; and
(iii) if the present operating factor is below a predetermined threshold value, then the electronic control circuit permits only a predetermined, limited set of functions to be performed by the electronic lockbox.

12. The electronic lockbox of claim 11, wherein: the predetermined, limited set of functions comprises allowing only the owner of the electronic lockbox to operate the prime mover driver.

13. The electronic lockbox of claim 11, wherein: the predetermined, limited set of functions comprises allowing only the owner of the electronic lockbox to command the prime mover driver to release a shackle of the electronic lockbox.
